(19) United States
(12) Patent Application Publication
(10) Pub. No.: US 2004/0213873 A1
(43) Pub. Date: Oct. 28, 2004

(54) Mineral waters containing dissolved calcium, phosphorus and zinc

(76) Inventor: Rifat Parvez, Skillman, NJ (US)

Correspondence Address: Gregory C. Houghton, Mathews, Collins, Shephard & McKay, P.A., Suite 306, 100 Thanet Circle, Princeton, NJ, 08540, US

(21) Appl. No.: 10/425,093

(22) Filed: Apr. 28, 2003

(51) Int. Cl. A23L 2/00

(52) U.S. Cl. 426/66

(57) ABSTRACT

The use of newly developed amino acid phosphate and amino acid citrate has been made in combination with carbonate salts of calcium and zinc to make it possible to obtain crisp, clear solutions in water. These waters, after further treatment with flavoring and/or sweetening additives, can be used as nutritional sources of calcium, phosphorus and zinc.

### FIELD OF THE INVENTION

The present invention relates to the most therapeutically important minerals, calcium, phosphorus and zinc in fortified bottled water for use by children, adults, the elderly and athletes, especially women.

### BACKGROUND OF THE INVENTION

Calcium is an essential mineral with a wide range of biological actions. Apart from being a major component of bones and teeth, calcium is crucial for muscle contraction, nerve conduction, beating of the heart, blood coagulation, glandular secretion, production of energy and the maintenance of immune function.

Calcium exists in bones and teeth primarily as calcium phosphate. Over 99% of the total body calcium is found in bones and teeth.

Calcium has anti-osteoporotic activity, as well as anticarcinogenic, anti hypertensive and hypocholesterolemic functions. A number of studies also suggest that calcium may reduce the risk of colorectal cancer (N Engl J Med. 1993; 313: 1381-1384; N Engl J Med. 1999; 340: 101-107). Calcium supplementation has been shown to have a modest effect on the reduction of systolic blood pressure in people with hypertension (Ann. Intern. Med. 1996; 124: 825-831; Arch. Fan. Med. 2000; 9: 31-39). While other studies have found calcium supplementation to lower serum cholesterol levels (Arch. Fam. Med. 1992; 152: 2441-2444).

The absorption of calcium varies throughout the life span, being highest (about 60%) during infancy and decreasing to about 25% during adulthood. In post-menopausal women, fractional absorption of calcium declines about 0.21% annually.

Absorption efficiency varies with different calcium complexes, being about 35% from calcium citrate, 27% from calcium carbonate and 29% from milk.

The combination of calcium and phosphorus is optimal for healthy bone development. The medical community has long touted the benefits of calcium for healthy bones and soft tissues and have now shown that the mineral phosphorus also plays an equally important role (Ann. Rev. Nutr. 1988; 8: 121-148).

Phosphorus is an integral part of many organic compounds and plays an important role in energy and protein metabolism. Phosphorus is a component of adenosine triphosphate (ATP), a fundamental energy source in living things. Almost every biochemical reaction that occurs within the human body involves phosphorus. It is found in complex organic compounds in the blood, muscles, nerves and calcium phosphate, the principle material that gives rigidity to bone and teeth (Int. J Sport Nutr. 1992; 2: 20-47).

Phosphorus intake in a normal diet is usually sufficient to meet standard nutritional guidelines. However, phosphorus deficiencies are prevalent. Phosphorus deficiency is generally treated with phosphorus supplements such as calcium phosphate.

Zinc is also an important element in human and animal nutrition. Zinc possesses catalytic, structural and regulatory roles in the more than 200 zinc metalloenzymes previously identified in biological systems. Metalloenzymes are mainly involved in nucleic acid and protein metabolism and the production of energy. Zinc also plays a structural role in the formation of the so-called zinc fingers, which are exploited by transcription factors for interacting with DNA and regulating the activity of genes (Science. 1996; 271: 1081-1085). Additionally, zinc is involved in the maintenance of the integrity of biological membranes and guards against oxidative injury.

Zinc is present in all of the body organs, tissues, fluids and secretions. Zinc is vital for growth and development, sexual maturation and reproduction, dark vision adaptation, olfactory and gustatory activity, insulin storage and for a variety of host immune defenses (J. Nutr. 2000; 130 (5S Suppl); 1378S-1383S). Publicized claims that zinc is efficacious in preventing and ameliorating symptoms of the common cold are also supported by Nutrition Reviews (Nutr. Rev. 1988; 106: 192-198).

Additionally, research suggests that iron and zinc stores are important not just in performance, but also exercise-related health problems. Researchers report that exercise-induced menstrual dysfunction may be due to different levels of iron and zinc, both of which, adversely affect bone health.

Nutritional supplement products containing calcium have been and continue to be available mostly in tablet formulations. The required daily amount of elemental calcium is 1000 mg for adults, and each calcium supplement tablet provides up to about one-half of the required daily amount of calcium for adults. These tablets are usually fairly large and hard to swallow by most people, especially older women who are in most need of this important mineral. The size of the tablet is dictated by the calcium salt used. The amount of elemental calcium available is highest in calcium carbonate (40%) and lowest in calcium gluconate (9.3%).

As mentioned above, phosphorus is almost always present as calcium phosphate which is essentially used as a delivery form of calcium or as a filler/binder in tablets. The amount of phosphorus available is far below the required daily amount of 700 mg. Therefore, while products providing 3-4 doses of calcium equaling the required daily amounts are available, similar products containing phosphorus do not exist.

Zinc is available in a host of nutritional supplement products. It is present in almost all multivitamin/mineral formulations, in tablets with calcium and magnesium and as lozenges. Dosage forms of zinc vary from 5 mg to 50 mg. The required daily amount for zinc is 15 mg.

The majority of mineral supplements that supply calcium, phosphorus or zinc in tablet form are far from palatable and in many instances nutritional components may be lost due to solubility problems within the stomach. Various drinks have been development to overcome these problems. Some are in dry form which are reconstituted in water and others are ready to serve.

U.S. Pat. No. 5,151,274 issued to Saltman et al. (assigned The Proctor & Gamble Company, 1992) describes nutritional improvements in calcium supplements that can be used in conjunction with foods and beverages or taken as an oral solid or liquid supplement.

U.S. Pat. No. 3,949,098 issued to Bangert (assigned to Nabisco, 1976) describes a nutritious orange drink concentrate that contains whey protein. The patent suggests other nutrients which include various cupric salts, manganese salts, zinc salts, as well as calcium salts.

U.S. Pat. No. 4,497,800 issued to Larsen et al. (assigned The Mead Johnson & Company, 1985) describes a nutritionally complete ready-to-use liquid diet for providing total patient nourishment. The diet contains free amino acids and small peptides, a carbohydrate source, and nutritionally significant amounts of all essential vitamins and minerals, and stabilizers. The minerals include calcium, copper, zinc and manganese, among others. Most of these minerals are given as a gluconate salt.

U.S. Pat. No. 4,214,996 issued to Buddenmeyer et al. (R. G. B. laboratories, 1980) discloses soluble mineral compositions. These compositions contain calcium, phosphorus, zinc, as well as manganese.

None of the prior art references disclose or suggest the unique combination of adequate amounts of calcium, phosphorus and zinc in a clear water solution, which can be bottled, containing the Required Dietary Allowance (RDA) of each mineral in easily consumable and palatable quantities.

### SUMMARY OF THE INVENTION

The present invention relates to a crisp and clear water solution that contains the Recommended Dietary Allowance of calcium, phosphorus and zinc. Since it is essential to have clean, crisp, clear water for acceptance, the use of an effervescent reaction is provided containing carbonate salts of zinc, calcium, amino-acid citrate and phosphate. Preferably, the amino acid, glycine (amino acetic acid), is used but the water solution may also consist of another suitable amino acid e.g. lysine, tyrosine, leucine, valine, alanine, etc. Glycine is advantageous in that it is inexpensive, amphoteric (basic-acid according to the medium), buffering agent, bacteriostatic, antioxidant, solubilizing agent and it increases bioavailability.

Stoichiometric ratios of glycine phosphate (monophospho glycine) and calcium carbonate (food and/or pharmaceutical grade) in water yields water containing calcium and phosphorus. The volume of water used is preferably twenty ounces but it can be lower or higher.

The ratios of the chemicals used are preferably stoichiometric but can be varied. Similarly the amount of calcium and phosphorus, per unit volume, can be varied from less than required daily amounts to more.

The stoichiometric ratios of glycine citrate and zinc carbonate, food and/or pharmaceutical grade, in water yields water containing zinc. The volume of water used is preferably eight ounces but it can be lower or higher. The ratios of the chemicals used are preferably stoichiometric but can be varied. The amount of zinc, per unit volume can also be varied.

The procedure for preparing the instant invention comprises admixing various ratios of calcium salts, zinc salts, amino acid citrate and amino acid phosphate in water. The addition in water causes an effervescent reaction which results in a clear solution of water containing completely dissolved calcium, zinc and phosphate. Calcium salts, zinc salts, amino acid citrate and amino acid phosphate can be mixed all at once or added separately one at a time.

The waters obtained in the above formulations can be used “as is” or more preferably enhanced by the addition of other ingredients e.g. sweetening agents, flavors, vitamins and other nutritional supplements.

### PREFERRED EMBODIMENT

In one embodiment, the present invention provides a clear water composition comprising water, calcium salts, zinc salts, amino acid phosphate and amino acid citrate, wherein the amounts of each of calcium, zinc, and phosphorus from amino acid phosphate are not less than 25% of the required daily amounts.

In another embodiment, the present invention provides a clear water composition further comprising stoichiometric ratios of calcium salts, zinc salts, amino acid phosphate and amino acid citrate.

In another embodiment, the present invention provides a clear water composition further comprising sweetening agents, flavors, vitamins and other nutritional supplements.

In another embodiment, the present invention provides a clear water composition, wherein the calcium salt is calcium carbonate and the zinc salt is zinc carbonate.

In another embodiment, the present invention provides a clear water composition, wherein the amino acid is selected from the group consisting of lysine, tyrosine, leucine, valine, alanine and glycine.

In another embodiment, the present invention provides a clear water composition, wherein the amino acid is glycine.

In another embodiment, the present invention provides a clear water composition comprising water, calcium carbonate, and glycine phosphate.

In another embodiment, the present invention provides a clear water composition comprising water, zinc carbonate, and glycine citrate.

In another embodiment, the present invention provides a clear water composition, wherein the amounts of calcium, zinc, and phosphorus from amino acid phosphate are not less than 50% of the required daily amounts.

In another embodiment, the present invention provides a clear water composition, wherein the amounts of each of calcium, zinc, and phosphorus from amino acid phosphate are not less than 100% of the required daily amounts.

In another embodiment, the present invention provides a clear water composition, wherein the clear water composition is bottled.

In another embodiment, the present invention provides a clear water composition, wherein the bottled water composition has a volume that is suitable for daily consumption by children, adults and the elderly, especially women and athletes.

In another embodiment, the present invention provides a method of making a clear water composition comprising the steps of:

Admixing in water:

(1) a calcium salt;

(2) a zinc salt;

(3) an amino acid phosphate; and

(4) an amino acid citrate.

In another embodiment, the present invention provides a method, wherein stoichiometric ratios of calcium salt, zinc salt, amino acid phosphate and amino acid citrate are used.

In another embodiment, the present invention provides a method further comprising the step of admixing sweetening agents, flavors, vitamins and other nutritional supplements.

### Definitions

As used herein, the term “nutritional” or “nutritional supplements” refers to mineral sources used in the practice of this invention that provide a nourishing amount of the minerals. This supplemental amount will comprise at least 25% of the Recommended Dietary Allowance (RDA) of the daily intake of minerals. The RDA for minerals is as defined in The United States of America (see Recommended Daily Dietary Allowance-Food and Nutrition Board, National Academy of Sciences-National Research Council). This is supplemental or in addition to the amount found in the diet.

As used herein, the term “flavors” includes both fruit and botanical flavors. The term “fruit flavors” refers to those flavors derived from the edible reproductive part of a seed plant, especially one having a sweet pulp associated with the seed. Also included within the term “fruit flavor” are synthetically prepared flavors made to simulate fruit flavors derived from natural sources. The term “botanical flavor” refers to flavors derived from parts of a plant other than the fruit; i.e. derived from beans, nuts, bark, roots and leaves. Also included within the term “botanical flavor” are synthetically prepared flavors made to simulate botanical flavors derived from natural sources. Examples of such flavors include cocoa, chocolate, vanilla, coffee, kola, tea, and the like. Botanical flavors can be derived from natural sources such as essential oils and extracts, or can be synthetically prepared.

As used herein, the term “sweetening agents” includes sugars, for example, glucose, sucrose and fructose. Sugars also include high fructose corn syrup, invert sugar, sugar alcohols, including sorbitol, and mixtures thereof. Artificial sweeteners are also included in the term sweetener.

Any soluble salt form of the minerals can be used, for example, zinc chloride, zinc carbonate and calcium carbonate. The inorganic anions which are useful for making the mineral salts are sulfate, nitrate, phosphate, hydrogen phosphate and carbonate.

As used herein, amino acids include but are not limited to lysine, tyrosine, leucine, valine, alanine and glycine.

As used herein, the term “water” includes tap, spring, purified, deionized, distilled and carbonate water.

What is claimed is:

1. A clear water composition comprising water, calcium salts, zinc salts, amino acid phosphate and amino acid citrate, wherein the amounts of said calcium, said zinc, and phosphorus from said amino acid phosphate are not less than 25% of the required daily amounts.

2. The clear water composition of claim 1 further comprising stoichiometric ratios of said calcium salts, zinc salts, amino acid phosphate and amino acid citrate.

3. The clear water composition of claim 1 further comprising sweetening agents, flavors, vitamins and other nutritional supplements.

4. The clear water composition of claim 1, wherein said calcium salt is calcium carbonate and said zinc salt is zinc carbonate.

5. The clear water composition of claim 1, wherein the amino acid is selected from the group consisting of lysine, tyrosine, leucine, valine, alanine and glycine.

6. The clear water composition of claim 5 wherein the amino acid is glycine.

7. A clear water composition comprising water, calcium carbonate, and glycine phosphate.

8. The clear water composition of claim 7 further comprising sweetening agents, flavors, vitamins and other nutritional supplements.

9. A clear water composition comprising water, zinc carbonate, and glycine citrate.

10. The clear water composition of claim 9 further comprising sweetening agents, flavors, vitamins and other nutritional supplements

11. The clear water composition of claim 1, wherein the amounts of said calcium, said zinc, and phosphorus from said amino acid phosphate are not less than 50% of the required daily amounts.

12. The clear water composition of claim 7, wherein the amounts of said calcium and phosphorus from said amino acid phosphate are not less than 50% of the required daily amounts.

13. The clear water composition of claim 9, wherein the amounts of said zinc is not less than 50% of the required daily amounts.

14. The clear water composition of claim 1, wherein the amounts of said calcium, said zinc, and phosphorus from said amino acid phosphate are not less than 100% of the required daily amounts.

15. The clear water composition of claim 7, wherein the amounts of said calcium and phosphorus from said amino acid phosphate are not less than 100% of the required daily amounts.

16. The clear water composition of claim 9, wherein the amounts of said zinc is not less than 100% of the required daily amounts.

17. The clear water composition of claim 1, wherein said clear water composition is bottled.

18. The clear water composition of claim 7, wherein said clear water composition is bottled.

19. The clear water composition of claim 9, wherein said clear water composition is bottled.

20. The clear water composition of claim 13, wherein said bottled water composition has a volume that is suitable for daily consumption by children, adults and the elderly, especially women and athletes.

21. A method of making a clear water composition comprising the steps of: Admixing in water:
(5) a calcium salt;
(6) a zinc salt;
(7) an amino acid phosphate; and
(8) an amino acid citrate.

22. The method of claim 15 wherein stoichiometric ratios of said calcium salt, zinc salt, amino acid phosphate and amino acid citrate are used.

23. The method of claim 15 further comprising the step of admixing sweetening agents, flavors, vitamins and other nutritional supplements.
